(19) United States
(12) Patent Application Publication
(10) Pub. No.: US 2026/0230492 A1
(43) Pub. Date: Aug. 6, 2026

(54) SECURE ACTIVE POLLING METHOD AND A SYSTEM THEREOF

(71) Applicant: Honeywell International Inc., Charlotte, NC (US)

(72) Inventor: Paul Smith, Calgary (CA)

(21) Appl. No.: 19/044,645

(22) Filed: Feb. 4, 2025

(51) Int. Cl. H04L 9/40; G06F 11/14

(52) U.S. Cl. CPC H04L 63/1433; G06F 11/1464; G06F 2201/80

(57) ABSTRACT

The present disclosure relates to an active polling method. The method comprises steps of creating (302), by an intrusion detection system, a bi-directional connection between at least one backup system and the intrusion detection system. The method further comprises generating (304) a pre-flight care query to initiate an active polling session and querying (306) the at least one backup system using it before initiating the active polling session. The method further comprises receiving (308) a response from the at least one backup system and initiating (310) the active polling session for the at least one node of the distributed control system if the response is negative or stalling (312) the active polling session for a pre-set time of the at least one node of the distributed control system if the response is affirmative.

### TECHNICAL FIELD

The present disclosure relates to active polling methods. More particularly, the present disclosure relates to a secure active polling method for a distributed system.

### BACKGROUND

The information age has enabled organizations to absorb, produce, and analyze massive volumes of data. Nowadays, information in the form of digital data has become part of the core of many organizations' operations. Consequently, data is presently one of the most valuable assets of many organizations in a variety of fields, and in some cases is considered to be the key asset of the organization. It has become a necessity for organizations which are reliant upon the data stored in their data systems to ensure the survivability and the recoverability of the organization's data, such that the organization may quickly and efficiently recover from any event resulting in massive damage to the organization's data systems.

The general code behind all data storage remote backup or mirroring systems is a presence of content or data on a node or system which by definition is to be copied to another computer system or backup server, such that the data and data structure on all or at least a portion of the backup server is substantially identical to the data and data structure on the nodes of the distributed system. When a node is first connected and configured to backup its data on the backup server, all the data on the node which should be backed up may be transmitted to, and stored on, the backup server, thereby producing a substantially identical copy of the data on the node. Sometimes, the backup server may be dedicated to the backup of data from a few specific nodes, while at other times a single backup server may store data from multiple nodes for data clients. After the initial data copying or synchronization between a node and a backup or cloning server, data on the node is rarely static and may change with any data transaction such as a data write request from a data client.

However, the issue of backup data not being updated after an IDS response is one of the challenges of maintaining data consistency in a dynamic, security-conscious environment. When an Intrusion Detection System (IDS) detects an attack or intrusion, it often triggers defensive actions to mitigate the threat, such as blocking suspicious IP addresses, quarantining compromised systems, or even rolling back changes made by the attacker. However, suppose the backup system is not synchronised with the latest actions taken by the IDS. In that case, the data restored from the backup may not reflect the system's state immediately following the intrusion response. This can lead to inconsistencies or the reintroduction of vulnerabilities during the recovery process.

For instance, if the IDS triggers automatic remediation steps like isolating files or restoring previous configurations, while a node is in a backup state, the backup system may not be aware of these changes, potentially restoring older versions of files that could reintroduce malware or open security holes. In such cases, even though the system appears to be restored to a stable state, the recovered data might still be vulnerable or incomplete, undermining the efforts to protect the environment post-attack.

FIG. 1 illustrates an exemplary polling system, showcasing a prior art system framework. The existing systems include various components intrusion detection system, a backup system, and a node. The intrusion detection system (IDS) may perform a wide variety of functions. For example, the intrusion detection system can act as a security tool designed to monitor network traffic. The backup system ensures data availability, integrity, and fault tolerance across multiple nodes or servers. The node in a distributed system is an individual computing unit that participates in the system's overall operation. The components like IDS and node can connect freely in an existing system. This leads to non-cohesive interactions that cause system inconsistencies.

When IDS and node interactions within a network are non-cohesive, several significant problems arise, especially in terms of security and performance. A non-cohesive interaction between IDS components and network nodes can lead to fragmented security coverage, where different nodes or parts of the system are unable to communicate effectively or share vital information. This lack of cohesion can result in blind spots in the network, where malicious activities or breaches go undetected. Further, non-cohesive node interactions can lead to performance bottlenecks. For instance, if an IDS cannot synchronize with certain nodes in real time, response times to potential security incidents can be delayed, allowing attacks to escalate before mitigation occurs. The result is a distributed network that is both vulnerable to attacks and inefficient in its operation

Additionally, when backup systems and intrusion detection systems (IDS) interact in a contradictory and non-coherent way, additional issues arise, especially in the potentially crucial areas of data integrity and system security. Generally speaking, backup systems are made to make copies of data and guarantee recovery in the event of errors or assaults.

However, non-cohesive interactions between IDS and backup systems can lead to inefficiencies and operational disruptions. Backup systems often run on predetermined schedules, and if they are not coordinated with the real-time security monitoring of an IDS, they may attempt to back up data at times when the system is under attack. For instance, if the IDS detects a ransomware attack but the backup system continues to run automatically, it could lead to the creation of backups that are infected, undermining the entire purpose of the backup. This dissonance can also complicate incident response efforts, as the backup system may restore compromised data without the necessary security checks, further exacerbating the problem. The lack of alignment between these two crucial components could thus lead to prolonged recovery times, greater data loss, and a compromised recovery process, severely impacting the resilience of the overall system.

To prevent this issue, it is crucial to integrate backup systems into the incident response process, ensuring that backup data reflects the current state of the system even after the IDS response.

Therefore, there exists a significant opportunity to improve IDS response by developing tools that are simple, optimize time & resources, and improve the overall productivity and efficiency of backup processes in any distributed system.

### SUMMARY

This disclosure provides a secure active polling method and a system thereof.

In an embodiment, a secure active polling method is disclosed. The method includes creating by an intrusion detection system, a bi-directional connection between at least one backup system and the intrusion detection system. The method further includes generating a pre-flight care query to initiate an active polling session with at least one node of a distributed control system. The method further includes querying, via the bi-directional connection, the at least one backup system using the pre-flight care query before initiating the active polling session and receiving a response from the at least one backup system. The method further includes initiating the active polling session for the at least one node of the distributed control system if the response is negative or stalling the active polling session for a pre-set time of the at least one node of the distributed control system if the response is affirmative.

In some embodiments, the response is affirmative when the at least one node is either in an automated backup state or in a manual backup state.

In some embodiments, the response is negative when the at least one node is not in a backup state or a cloning state.

In some embodiments, the active polling session is a batch of active polling actions of an active polling scheme.

In some embodiments, the active polling session is used for cyber insights of the at least one node of the distributed control system.

In some embodiments, the at least one node is a device with an operating system.

In some embodiments, the at least one backup system is selected from a group of local servers or remote servers.

In some embodiments, the method further comprises storing, by the intrusion detection system, the response along with a plurality of associated metadata.

In some embodiments, the method further comprises generating a subsequent pre-flight care query based on the stored response being affirmative and the associated metadata, before initiating an active polling session of the at least one node of the distributed control system. The method further includes querying the at least one backup system using the subsequent pre-flight care query. The method further includes receiving a subsequent response from the at least one backup system. The method further includes initiating the active polling session for the at least one node of the distributed control system if the subsequent response is negative or stalling the active polling session for a subsequent pre-set time of the at least one node of the distributed control system if the subsequent response is affirmative.

In yet another embodiment, an intrusion detection system to execute an active polling session for at least one node of a distributed control system is disclosed. The intrusion detection system includes a connection module that is configured to create a bi-directional connection between at least one backup system and the intrusion detection system. The intrusion detection system further includes a query formulation module that is configured to generate a pre-flight care query before initiating an active polling session for the at least one node of the distributed control system. The intrusion detection system further includes a query execution module that is configured to query the at least one backup system using the pre-flight care query. The intrusion detection system further includes a decision module that is configured to receive a response from the at least one backup system via the bi-directional connection and is further configured to initiate the active polling session for the at least one node of the distributed control system if the response is negative or further configured to stall the active polling session for a pre-set time for the at least one node of the distributed control system if the response is affirmative.

In some embodiments, the response is affirmative when the at least one node is either in an automated backup state or in a manual backup state.

In some embodiments, the response is negative when the at least one node is not in a backup state or a cloning state.

In some embodiments, the active polling session is a batch of active polling actions of an active polling scheme.

In some embodiments, the active polling session is used for cyber insights of the at least one node of the distributed control system.

In some embodiments, the at least one node is a device with an operating system.

In some embodiments, the at least one backup system is selected from a group of local servers or remote servers.

In some embodiments, the system includes storing the response along with a plurality of associated metadata.

In some embodiments, the system is further configured to execute the steps of generating a subsequent pre-flight care query based on the stored response being affirmative and the associated metadata before initiating an active polling session of the at least one node of the distributed control system. The system further includes querying the at least one backup system using the subsequent pre-flight care query and receiving a subsequent response from the at least one backup system. The system further includes initiating the active polling session for the at least one node of the distributed control system if the subsequent response is negative or stalling the active polling session for a subsequent pre-set time of the at least one node of the distributed control system if the subsequent response is affirmative.

In some embodiments, the pre-set time is part of a plurality of pre-set rules defined automatically by the intrusion detection system or by using a user input.

In yet another embodiment, a non-transitory computer-readable medium is disclosed, having stored thereon computer-readable instructions that, when executed by a processor, cause the processor to execute a secure active polling method, comprising creating, by an intrusion detection system, a bi-directional connection between at least one backup system and the intrusion detection system. The computer-readable instructions further cause the processor to generate a pre-flight care query to initiate an active polling session with at least one node of a distributed control system. The computer-readable instructions further cause the processor to query, via the bi-directional connection, the at least one backup system using the pre-flight care query before initiating the active polling session and receive a response from the at least one backup system via the bi-directional connection. The computer-readable instructions further cause the processor to initiate the active polling session for the at least one node of the distributed control system if the response is negative or stall the active polling session for a pre-set time of the at least one node of the distributed control system if the response is affirmative.

The disclosed secure active polling method and the system offer a sophisticated approach to handle nodes of a distributed system that are going into a backup or a cloning state, for enhanced recovery efficiency, synchronicity and reduced vulnerabilities. The method begins with forming a bi-directional connection between the backup system and the intrusion detection system (IDS). This enables the intrusion detection system to communicate with the backup systems directly before initiating any active polling session for a node. This node can be any device with an operating system that is part of the distributed system. Further, the active polling session is a batch of active polling actions of an active polling scheme and is used for cyber insights of the at least one node of the distributed control system.

The intrusion detection system would generate a pre-flight care query to check the status of a node in the distributed system. The intrusion detection system then queries the backup system using the pre-flight care query via the bi-directional connection. The backup system processes the pre-flight query and generates a response. The generated response is negative when the node is not in a backup state or a cloning state. The response is affirmative when the node is either in an automated backup state or in a manual backup state.

The backup system prepares the response carrying a status of the backup state of the node in question along with its associated meta data. The response is sent to the intrusion detection system along with the associated metadata for further processing. The intrusion detection system analyses the response upon receiving it from the backup system via the bi-directional connection. The active polling session is initiated for the node of the distributed control system by the IDS, when the response received by the intrusion detection system carries a negative value. Further, the active polling session is stalled for a pre-set time for that node if the response received by the intrusion detection system carries a positive value.

When the active polling session is stalled due to the positive response, the intrusion detection system saves the response along with its metadata. Post a pre-set time, the intrusion detection system generates a subsequent pre-flight care query based on the stored response and associated metadata. This is done before re-initiating the stalled active polling session for the node of the distributed control system.

The intrusion detection system sends the subsequent pre-flight care query to the backup system to know the current status of the node. The backup system receives the subsequent pre-flight care query and processes it to generate a subsequent response. The backup system sends the subsequent response to the intrusion detection system.

The intrusion detection system initiates the active polling session for the node if the received subsequent response is negative or else the intrusion detection system stalls the active polling session for a subsequent pre-set time of the node of the distributed control system if the subsequent response is affirmative.

The intrusion detection system continues to query the backup system till it gets a go ahead to execute the active polling session with the node in question.

The secure active polling method for a distributed system addresses the challenge of maintaining data consistency after an intrusion detection system active polling session is executed. The method seamlessly integrates backup processes with real-time intrusion detection and incident response actions. This system ensures that whenever the intrusion detection system triggers defensive actions—such as isolating files or rolling back changes—these updates are immediately synchronized with the backup system. By continuously monitoring the security posture of the environment, the backup solution is able to capture the state of the system post-response, ensuring that any backup data reflects the latest security measures taken and not outdated or compromised versions. This real-time synchronization prevents the reintroduction of vulnerabilities during recovery, ensuring that restored data is both complete and secure, preserving the integrity of the system even after an attack.

Other technical features may be readily apparent to one skilled in the art from the following figures, descriptions, and claims.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

For a more complete understanding of this disclosure and its features, reference is now made to the following description, taken in conjunction with the accompanying drawings, in which:

FIG. 1 illustrates an exemplary polling system showcasing a prior art system framework;

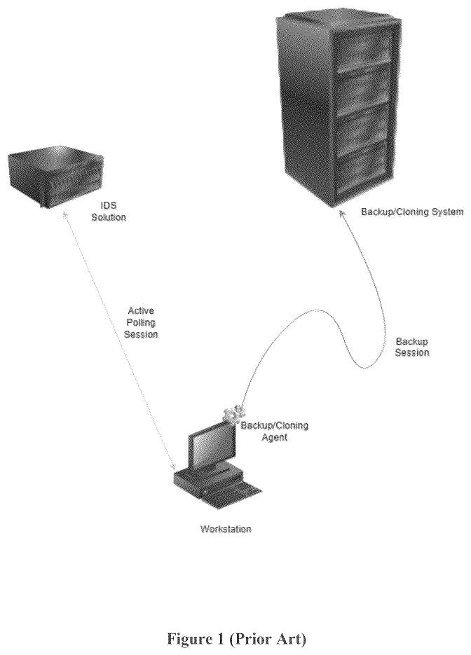

FIG. 2 illustrates a schematic diagram of a secure active polling system according to an embodiment of the disclosure;

FIG. 3 illustrates a flowchart of a secure active polling method according to an embodiment of the disclosure;

FIG. 4 illustrates an intrusion detection system to execute an active polling session for a node according to an embodiment of the disclosure; and

FIG. 5 illustrates a schematic diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

Embodiments of the present invention can provide a system that can store and regularly update backup data of a computer system, including an operating system, applications and data. The data can be stored on any suitable device adapted to store digital information, according to the needs of a client. For example, to recover from a failure of a partition, the data can be stored on another partition of the same drive used by the computer system. Alternatively, the data may be stored on an external drive coupled (e.g., via USB) to the computer system. To provide continuity of operations across the loss of a site (e.g., due to fire, acts of war, etc.), the data can be stored on a remote system, e.g., thousands of miles away from the computer system.

Backup software on the computer system can cause the computer system to track changes to the data and send updates (which can be sent periodically, a periodically or in response to a triggering condition or event) to a backup system. Software at the backup system can update the backup data based upon the contents of the updates. In the event of a failure of the computer system, the up-to-date data can be loaded onto another secondary system, which when running can essentially duplicate a recent state of the computer system before failure. In one embodiment, the backup data can be used to activate a remote virtual server to which users can be redirected after failure of the primary site. In another embodiment, the computer system can be restored after power is restored or the computer system is repaired. This can be done by loading the backup data onto the repaired computer system and activating it.

At least one of primary and backup data storage system control modules can coordinate the copying of data to the secondary data storage system, where the secondary data storage system is preferably a backup appliance such as a Network Attached Storage device (“NAS”). As used herein, “storage” can include all or part of a hard disk, RAM, ROM, flash memory, an external drive and any other device adapted to store electronic information. “Primary server storage,” “network attached storage device,” etc. can include any all or part of any such device that is usable by a primary server, a network storage device, etc., respectively. Information may be transferred between the primary and backup data storage system controllers synchronously, when a primary host computer requests writing of data to a primary data storage device, or asynchronously with the primary host computer requesting the writing of data to the primary data storage system, in which case the remote data copying or mirroring is independent of and largely transparent to the primary computer system. Data may also be similarly transferred between the primary or NAS and a remote storage server, thus providing an additional layer of failure protection.

The backup data can include a disk or partition image from the primary server system. The initial data may be a complete compressed block level copy of the primary server's hard drive patterns and can include a boot level backup feature. Once the initial data is transferred, incremental or differential changes can subsequently be composed and sent to the backup device or storage unit. These updates may utilize bandwidth limiting and throttling such that primary server functionality is largely unaffected by the backup work. For example, the updates can be sent as a second or lower priority to functions performed by the primary computer system. For example, an update transmission can be held while a user at the primary computer system views a streamed video that requires substantial bandwidth to properly display. An update transmission rate can be slowed while the video is being streamed to prevent interruptions in the viewed video, and then increased when the video is finished, and the bandwidth becomes available. The timing of the updates can be controlled by a user or administrator of the primary computer system.

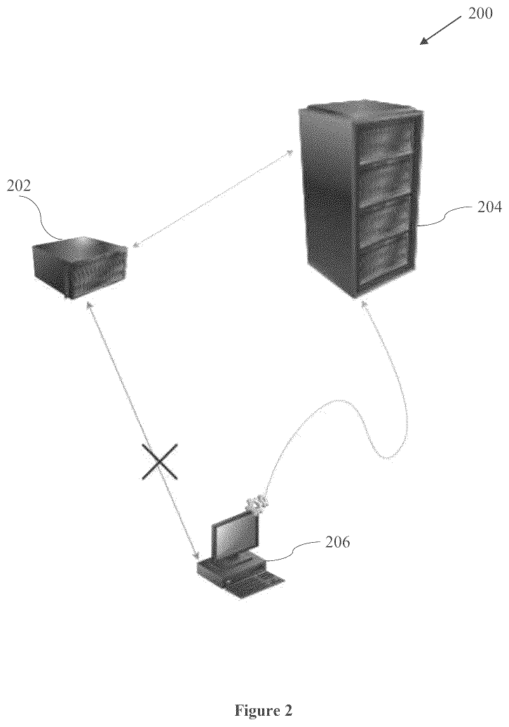

FIG. 2 illustrates a schematic diagram of a secure active polling system hereinafter interchangeably referred to as “a secure active polling system 200”, “an active polling system 200”, or “a system 200”, according to an embodiment of the disclosure. The secure active polling system 200 includes various components, including but not limited to, an intrusion detection system 202, one or more backup system 204 and one or more nodes 206. The intrusion detection system 202 represent components in the system 200 that may perform a wide variety of functions. For example, the intrusion detection system (IDS) 202 can act as a security tool designed to monitor network traffic and activities for signs of malicious activity or violations of security policies. Further, the one or more backup system 204 performs activities like scheduling backups, managing storage space and the like. The node 206 in a distributed system is an individual computing unit that participates in the system's overall operation, typically consisting of a workstation, or a device with its own resources such as processing power, storage, and memory.

In an embodiment, the intrusion detection system 202, the backup system 204, and the node 206 are connected to at least one network, which helps the intrusion detection system 202, the backup system 204, and the node 206 communicate and operate together. In an exemplary embodiment, the network could transport data from the intrusion detection system 202 to the node 206 and vice versa. In another exemplary embodiment, the network could further transport data to and from the node 206 and the backup system 204. The network could represent any suitable network or combination of networks. For example, the network could represent an Ethernet network, an electrical signal network, (including but not limited to a HART or FOUNDATION FIELDBUS network), a pneumatic control signal network, or any other or additional type(s) of network(s).

In another embodiment, the intrusion detection system 202 can further be classified into two main types: Network-based IDS (NIDS), which monitors network traffic, and Host-based IDS (HIDS), which focuses on individual devices or hosts. By analysing patterns, signatures, or anomalies, the intrusion detection system 202 can detect a range of threats, including unauthorized access, malware infections, or data breaches. Once an intrusion is identified, the intrusion detection system 202 can either alert administrators or, in some cases, take proactive measures to block the threat. The intrusion detection system 202 plays a crucial role in enhancing network security by providing real-time detection and helping organizations respond swiftly to potential security incidents.

In another embodiment, the one or more backup system 204 perform an important role across multiple nodes and/or servers. Since the distributed systems involve a network of interconnected devices that may fail independently, the backup system 204 helps protect against data loss due to hardware failures, network issues, or malicious attacks. Typically, the backup system 204 in distributed environments involves techniques like replication, where data is stored on multiple nodes, or incremental backups, where only changes since the last backup are saved. These backups can be local (within the same data centre) or remote (across different geographic locations) to safeguard against regional failures. Effective backup strategies in distributed systems ensure that, in the event of a failure, the system can quickly recover and maintain its reliability and availability without significant service disruption. The backup system 204 ensures data availability, integrity, and fault tolerance across multiple nodes or servers.

In another embodiment, the node 206 communicate with each other over a network to share data and perform tasks collaboratively. Each node 206 can act autonomously or depend on other nodes 206 for processing and resources, depending on the system's architecture. In a distributed system, the nodes 206 are often designed to be fault-tolerant, ensuring that the failure of one node 206 does not significantly disrupt the overall system's functionality.

Various components shown in FIG. 2 can regulate the active polling sessions for nodes. When the IDS generate a pre-flight care query, before initiating an active polling session for the safe operations of the nodes, it in turn protects the complete distributed system against malfunction. These components work together to ensure a secure, resilient, and efficiently managed distributed system, where potential threats are detected early, data is protected through continuous backups, and node functionality is continuously monitored through a secure polling system 200.

The secure polling mechanism regulates the health and operational status of nodes within the distributed system. The mechanism plays a pivotal role in maintaining the health and reliability of nodes within a distributed system. The secure polling sessions are conducted to check the status of each node, ensuring it is actively functioning and responding as expected. Periodic polling involves a central or monitoring node regularly sending requests to each individual node to check its status and gather important performance metrics, such as CPU usage, memory consumption, response times, and error logs. These requests allow the system 200 to monitor node availability and health, ensuring that nodes are functioning as expected.

The responses from the nodes are analysed to detect any anomalies or potential failures, such as high resource usage or unresponsiveness, and to trigger alerts or corrective actions as needed. If a node becomes unresponsive or experiences issues, the polling system triggers failover processes or alerts to maintain system integrity and performance. By regularly checking each node's 206 status, the system ensures continuous availability, proactive failure management, and optimal performance. Through these well-structured polling mechanisms, administrators can quickly respond to issues, ensuring the overall system remains secure, efficient, and resilient.

Although FIG. 2 illustrates one example of a secure active polling system 200, various changes may be made to FIG. 2. For example, the system 100 could include any number of IDS, backup systems, nodes, networks, and may also include control units, servers, and other components. Also, the arrangement of the system 200 in FIG. 2 is for illustration only. Components could be added, omitted, combined, further subdivided, or placed in any other suitable configuration according to particular needs.

Further, particular functions have been described as being performed by particular components of the system 200. This is for illustration only. In general, distributed systems are highly configurable and can be configured in any suitable manner according to particular needs. In addition, FIG. 2 illustrates one example operational setting where secure active polling techniques could be used. This functionality can be used in any other suitable system.

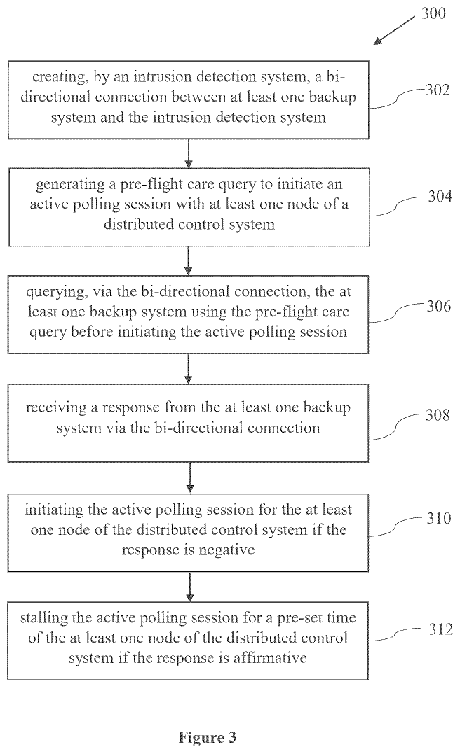

FIG. 3 is a flowchart illustrating a secure active polling method 300 according to an embodiment of this disclosure. For ease of explanation, the method 300 is described with respect to the secure active polling system 200 of FIG. 2. The method 300 could be used with any suitable device and in conjunction with any suitable system.

The method 300 comprises creating a bi-directional connection between at least one backup system 204 and the intrusion detection system 202, as shown in step 302. This could include, for example, a request to connect sent from the intrusion detection system 202 to at least one backup system 204. The backup system can be a group of local servers or remote servers working as a part of the system 200. A request to connect sent from the intrusion detection system (IDS) 202 to at least one backup system 204 typically arises in response to a detected security event, where the system 200 needs to ensure that critical data and configurations are preserved and recoverable. In the event of a detected intrusion or anomaly, the system 200 may send a connection request to a backup environment to perform actions such as current system states of a node.

The backup system 204, which could be cloud-based or on-premises, serves as a secure repository for vital information, allowing for the recovery of lost or corrupted data in case of an attack, system failure, or breach. The communication between the IDS 202 and backup system 204 is tightly controlled, with strong encryption and access control policies to prevent unauthorized access. The backup system 204 may also be configured to only accept connections under certain conditions, such as when specific security alerts are triggered by the IDS 202.

This connection ensures a layered defence strategy, providing a failsafe to ensure that, data and operations can be swiftly performed without significant downtime or loss of critical information.

The method further comprises generating a pre-flight care query to initiate an active polling session with at least one node of a distributed control system, as shown in step 304. A node 206 is a device with an operating system.

An active polling session refers to a batch of active polling actions carried out within an active polling scheme by the IDS 202. In this context, the active polling scheme outlines the methodology for periodically checking or retrieving data from the network or system, such as querying logs, monitoring network traffic, or inspecting system configurations for anomalies. Each individual action within the scheme involves a specific task or query aimed at detecting potential security threats in real-time. The polling session consists of a series of these actions executed together over a set period, allowing the IDS 202 to actively monitor and respond to suspicious activities or intrusions as they occur, ensuring continuous threat detection rather than relying solely on reactive measures. This functionality ensures real-time or near-real-time data collection, with advantages including efficient management of resources and timely responses to system status or events.

In an embodiment, the active polling session is used for cyber insights of the at least one node of the distributed control system.

The method further comprises querying, via the bi-directional connection, the at least one backup system 204 using the pre-flight care query before initiating the active polling session, as shown in step 306. An automated process, such as the IDS 202, detects a security breach or system anomaly, which prompts the IDS 202 to form a pre-flight query to retrieve backup data status for the affected node.

In this step, the system formulates the pre-flight query to access the backup storage, which may involve different approaches depending on the type of backup system being used. The method of querying may vary based on whether the backup server is local, cloud-based, or a hybrid of the two.

Local Backups: When the backup system is local (such as a network-attached storage (NAS) device or a dedicated backup server), the pre-flight query is typically formulated by searching for specific snapshots within the local storage infrastructure. In this case, the pre-flight query might specify criteria such as the date and time of the backup, the node's identifier, or the specific type of data needed from the backup system as metadata. It also ensures that the metadata is in the correct format.

Cloud-Based Backups: For cloud-based backup systems, such as those using services like Amazon Web Services (AWS) S3, Google Cloud Storage, or Microsoft Azure Blob Storage, the pre-flight query typically involves API calls to the cloud provider's storage service. Cloud storage APIs allow users to search for the backup status based on predefined data, such as the node's ID, timestamp, or tags that classify the backup data. These pre-flight queries are often more flexible, allowing for granular search for metadata.

Database Query: If the backup system involves storing data in a structured database (e.g., relational databases like MySQL, PostgreSQL, or NoSQL databases like MongoDB), the pre-flight query is formulated using database query languages like SQL or NoSQL-specific query syntax. In this scenario, the system might search for specific metadata related to the node's backup status, based on attributes such as node identifiers, dates, or backup status. The database query ensures that the correct version of the backup metadata is retrieved and is designed to handle backup metadata in a normalized or distributed manner.

Each of these methods ensures that the system can retrieve the appropriate backup status and metadata based on the storage infrastructure and specific query parameters, enabling efficient analysis of the node's backup.

The method further comprises receiving a response from the at least one backup system 204 via the bi-directional connection, as shown in step 308. Receiving the response from the backup system 204 via the bi-directional connection is a critical step in the process of querying and retrieving backup status. Once the backup system 204 receives the pre-flight query, it processes the request and begins the retrieval of the requested data. The bi-directional connection facilitates two-way communication between the querying IDS 202 and the backup system 204, enabling a seamless exchange of information.

On the sender's side, the querying IDS 202 initiates the pre-flight query request with specific parameters, such as the node identifier, the time range, and the type of data needed. The backup system 204, after receiving the pre-flight query, will typically perform a search in its storage, whether local, cloud-based, or hybrid, and prepare the appropriate response based on the parameters provided. Once the backup system 204 locates and verifies the requested backup data, it sends a response back to the querying IDS 202. This response may include a confirmation of the backup status, and any metadata associated with the backup, like its integrity status, timestamp, or many more.

The bi-directional connection ensures that the communication between systems is secure, efficient, and resilient. This allows for real-time monitoring of the status of the pre-flight query and provides opportunities for error handling in case of issues such as data corruption, access control violations, or connection interruptions. When the response to the pre-flight query backup data is too large, the backup system 204 may also send it in chunks, furthermore, secure encryption protocols are often used to protect the data during transmission if required. Once the backup system 204 successfully sends the data, the IDS 202 can then begin the analysis process.

The method further comprises initiating the active polling session for the at least one node 206 of the distributed control system if the response is negative, as shown in step 310.

The method further comprises stalling the active polling session for a pre-set time of the at least one node 206 of the distributed control system if the response is affirmative, as shown in step 312. Stalling the active polling session for a pre-set time of at least one node 206 in a distributed control system is a strategic step. This helps manage the flow of requests and responses regarding node back up or mirroring, particularly in scenarios where the response from the backup system 204 has been affirmed. Once the system receives a positive confirmation from the backup system 204, indicating that the query was successful, the polling session has to be temporarily paused as the node(s) are in a backup state. This delay ensures that the system does not continue to initiate the active polling session while the current restoration or analysis process is in progress on the node(s). By implementing a pre-set time for stalling the polling session, the system avoids introducing unnecessary load on the network.

The stalling period also gives the IDS time to process and analyze the received backup metadata. For example, if the backup data is being restored to a node or if certain files need to be examined for forensic purposes, pausing the polling session allows the system to complete these tasks without interruption. During this stalling phase, the system can also verify the integrity of the received data, ensuring that no issues or discrepancies were encountered during the pre-flight query processing. The pre-set time for stalling is typically configured based on the size of the backup, the complexity of the mirroring in progress.

Moreover, stalling the polling session helps synchronize the actions of the nodes 206 in the distributed control system. In a networked environment, where multiple nodes may rely on a single backup or restoration event, pausing polling for the nodes ensures that the backup is completed without interruption. It prevents simultaneous backup queries and polling sessions from creating conflicts or excessive traffic, ensuring that the system can focus on executing tasks in an orderly and efficient sequence.

In an embodiment, the IDS 202 stores the response along with a plurality of associated metadata of the node 206.

In an embodiment, once the stalling period expires, the polling session can be resumed for the node 206. To resume the polling, a subsequent pre-flight care query is generated. The subsequent pre-flight care query is generated using the stored response and the associated metadata for the node before resuming the polling. The system repeats the whole process before initiating the active polling session again for any node of the distributed control system. Once again, the backup system 204 is queried using the subsequent pre-flight care query. The backup system 204 processes and generate a subsequent response for the subsequent pre-flight care query. The backup system 204 sends the subsequent response to IDS 202 for further actions.

Upon receiving the subsequent response from the backup system 204, the IDS 202 starts to analyze it further. The IDS 202 initiates the active polling session for the node(s) 206 of the distributed control system if the subsequent response is negative. The IDS 202, however, again stall the active polling session for a subsequent pre-set time of the node 206 if the subsequent response is affirmative.

In an exemplary embodiment, a distributed network is formed by multiple interconnected systems or nodes working together to provide services, share resources, and manage data. Given the risks associated with cyberattacks, network vulnerabilities, and potential system failures, a combination of an IDS and a Backup System is critical to maintain the integrity, availability, and confidentiality of the network's data. It is important to focus on a scenario where one of the nodes is in the backup state as the system may go into various inconsistencies with node being in a backup or cloning state.

A distributed application runs across several nodes. These nodes may handle sensitive customer data, process transactions, and provide services to users. To ensure resilience against potential attacks, hardware failures, and disasters, the IDS monitors for potential attacks. Network Architecture of such a system may be as follows. Nodes—These are the active nodes that handle requests, process data, and interact with users. Backup system replicates the node's data as a backup to cover in case of a failover in case of any incident. This system performs regular backups of data, configurations, and states of the nodes, ensuring recovery after failure or corruption. The IDS is deployed across the network to monitor, detect, and respond to suspicious activities.

As the IDS is continuously monitoring all network traffic, examining each node's activity for signs of any malicious attempts or abnormal behaviours that could indicate a security breach. The IDS uses techniques such as 1). Signature-based detection: here a comparison of incoming traffic and behaviour with known attack patterns or signatures is performed; Or 2). Anomaly-based detection: The system builds a baseline of normal network behaviour and flags any traffic or activity that deviates significantly from that baseline; or 3). Behavioural analysis: IDS also monitors the behaviours of systems or users, looking for unexpected or potentially harmful actions, like unauthorized access attempts, privilege escalation, or data exfiltration.

For instance, if a user from an untrusted location attempts to access a restricted portion of the network or injects malicious code into an application, the IDS would immediately detect it. If a Distributed Denial of Service (DDoS) attack occurs, where multiple compromised systems try to overwhelm one of the nodes, the IDS can quickly identify the attack pattern and trigger an alert.

When the IDS detects an intrusion attempt on one Node, such as an unexpected spike in traffic patterns or suspicious login attempts that may indicate a brute-force attack. The IDS quickly responds to such detections.

At this point, the IDS may take following actions.

Real-time blocking: If the IDS is configured with intrusion prevention capabilities, it may take automatic actions, such as blocking the malicious IP addresses or throttling traffic to prevent further damage.

Incident response: Security teams may start investigating the attack, using forensic tools and data logs provided by the IDS.

Given the detection of potential threats of one Node, the IDS need to initiate an active polling strategy which can be any one of the above or a combination. However, initiating such polling session can be problematic for a node in a backup state. So, the IDS prepares a pre-flight query to mitigate this challenge. IDS forms a pre-flight query and sends it to the backup system.

The IDS may ensure security and may use a node isolation i.e., the node is isolated from the rest of the network temporarily, preventing any further communication or data corruption until the attack is fully mitigated. However, the node continues to finish the backup with the backup system.

The backup system plays a vital role in ensuring that the IDS communicates with an optimum response to the pre-flight query. To ensure the same, the backup system checks the node status and responds to the pre-flight query along with metadata. The IDS takes a call to initiate or stall the active polling session based on the response and the metadata.

In this scenario, the IDS actively detects and alerts on an ongoing attack, providing real-time threat intelligence that helps security teams isolate the affected node (N1). The Backup System ensures that a replicated, secure version of the node's data and services exists in the node, and the node is not in any backup state, enabling the network to quickly recover by transitioning to the backup node without service interruptions. This interplay between the IDS and backup system ensures both immediate response to intrusions and long-term resilience by enabling quick recovery with minimal data loss. Together, they safeguard the integrity, confidentiality, and availability of the distributed network, minimizing damage from cyberattacks and ensuring smooth business continuity.

An embodiment of this application further provides a non-transitory computer-readable medium. The computer-readable storage medium stores computer-readable instructions. When the computer-readable instructions are executed by a processor, the computer may implement technical solutions related secure active polling in any one of the embodiments as shown in FIG. 2 to FIG. 3 in the foregoing method embodiments. The phrase “computer readable instructions” includes any type of computer code, including source code, object code, and executable code. The phrase “computer-readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable storage device.

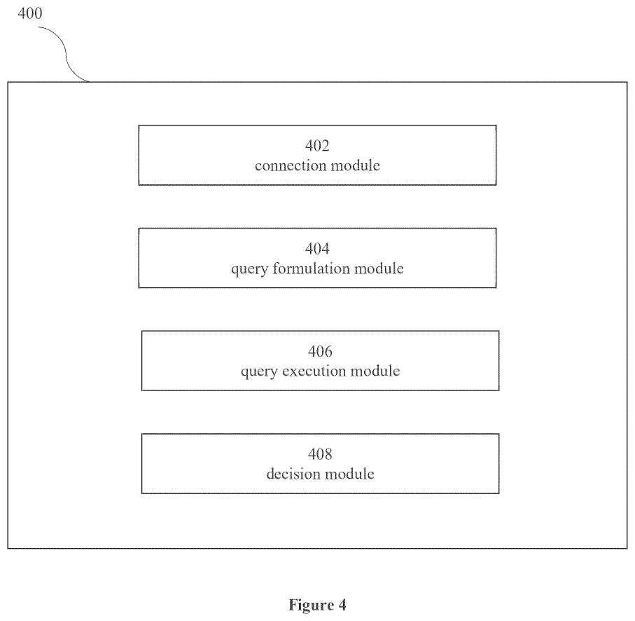

FIG. 4 illustrates an intrusion detection system 400 to execute an active polling session for a node of a distributed system according to an embodiment of the disclosure. The intrusion detection system 400 comprises a connection module 402, a query formulation module 404, a query execution module 406, and a decision module 410.

The connection module 402 creates a bi-directional connection between at least one backup system and the intrusion detection system.

The query formulation module 404 generates a pre-flight care query, before initiating an active polling session, for the at least one node of the distributed control system.

The query execution module 406 queries the at least one backup system using the pre-flight care query.

The decision module 408 receives a response from the at least one backup system via the bi-directional connection and further configured to initiate the active polling session for the at least one node of the distributed control system if the response is negative or further configured to stall the active polling session for a pre-set time for the at least one node of the distributed control system if the response is affirmative.

In an embodiment, the response is affirmative when the at least one node is either in an automated backup state or in a manual backup state and the response is negative when the at least one node is not in a backup state or a cloning state.

In another embodiment, the active polling session is a batch of active polling actions of an active polling scheme, and the active polling session is used for cyber insights of the at least one node of the distributed control system.

In another embodiment, the at least one node is a device with an operating system.

In another embodiment, the at least one backup system is selected from a group of local servers or remote servers.

In another embodiment, the system further stores the response along with a plurality of associated metadata.

The disclosed secure active polling method and system present a comprehensive approach to enhancing the efficiency and safety of a distributed system. By automating the association of operational backup and cloning activities to cybersecurity active polling actions, the system 200 eliminates downtime caused by such active polling actions. By protecting the nodes in backup from unnecessary interactions, the system 200 ensures a swift response to failures, minimizes network congestion and maintains the security and stability of the entire infrastructure.

The secure active polling method involves several key steps. Initially, the intrusion detection system identifies suspicious activities or intrusions for at least one node. Before initiating an active polling session with the node, in response to the identified suspicious activity or intrusion, the IDS initiates a connection with a backup system of the distributed network.

This connection is used to send a pre-flight query. The pre-flight query is designed to seek clearance from the backup system. The backup system receives the pre-flight query formed for a particular node and processes the pre-flight query. The backup system generates a response to the pre-flight query sent by IDS for the node. The response is sent along with a plurality of metadata associated with the response, like a time stamp, retry attempt time, notification logs and the like.

This approach offers several advantages, including reducing the triggers of nodes in a backup state to preserve resources and allowing these nodes to focus on staying synchronized with the backup server. Moreover, limiting unnecessary polling actions reduces network congestion and minimizes latency, leading to better overall performance of the system. Nodes in backup are not burdened by polling tasks, hence can concentrate on maintaining their readiness without interference, which is critical for quick and seamless recovery when needed.

Additionally, the system safeguard nodes in backup, by not giving any active polling action to such nodes and that helps to prevent false failover triggers, which can occur if polling actions mistakenly indicate an issue with the node in a backup state. This reduces the risk of unnecessary disruptions and ensures that failovers only occur when truly needed. By isolating nodes in cloning or in backup states from constant checks, the system becomes more secure, with fewer opportunities for vulnerabilities to be exploited. Ultimately, this approach results in cost savings, as fewer resources are consumed by unnecessary traffic, and the system operates more efficiently, with a lower risk of downtime or unnecessary management overhead of a distributed system.

In an specific embodiment, consider a Building Management System (BMS) that is also known as a Building Automation System (BAS), using the system described in FIG. 2. The BMS is a control system used to manage and monitor the mechanical, electrical, and electromechanical services in a building. It integrates various systems within the building, such as heating, ventilation, air conditioning (HVAC), lighting, security, fire safety, energy management, and more, to optimize performance, energy efficiency, comfort, and safety. The traditional BMS architectures tend to be centralized, where a central control unit manages all subsystems (HVAC, lighting, security, etc.) of the building. However, newer BMSs are mostly distributed BMS that may have multiple controllers or units placed throughout the building or complex, each responsible for managing specific subsystems or areas. These controllers communicate with each other and may be monitored and controlled centrally. In larger buildings or multi-building complexes, a BMS can be part of a distributed management system where it is integrated with other systems like energy management, facility management, and security management.

As the Building Management Systems (BMS) are critical for the efficient and safe operation of modern buildings, these systems integrate various technologies to control and monitor a building's infrastructure, such as HVAC (heating, ventilation, and air conditioning), lighting, security, and energy management. Key components of distributed BMS that play an important role in building security and operational continuity are Intrusion Detection Systems (IDS), Backup Systems, and Nodes.

Intrusion Detection Systems (IDS) are designed to detect unauthorized access or potential threats within a building or facility. These systems monitor and protect the building against security breaches, physical intrusions, or malicious activities, contributing to the safety and security of the building's occupants and assets. Backup systems are critical for ensuring that a building's operations continue seamlessly even during power outages, hardware failures, or system malfunctions. They are designed to protect data, maintain system functionality, and minimize downtime. The Nodes refer to the individual components or devices that communicate and exchange data within the system. They play a crucial role in the overall operation of the BMS by helping control, monitor, and automate various building functions such as lighting, HVAC (heating, ventilation, and air conditioning), security, energy management, and other systems. These nodes are usually computer systems with processing capabilities.

The Intrusion Detection System (IDS) ensures security through continuous detection and monitoring of unauthorized activities. The IDS constantly scans the building for anomalies, sending alerts to the BMS when irregularities are detected. Using advanced technologies like artificial intelligence and machine learning, the BMS can analyze activity patterns to reduce false alarms and predict potential intrusions. Upon detecting a breach, the BMS automatically initiates predefined responses, such as locking access points, disabling HVAC systems, or activating emergency lighting for safe evacuation. Security personnel are notified, and surveillance footage can be accessed remotely for real-time verification. The system also logs each event, capturing essential details such as time, type of intrusion, and the actions taken, which are crucial for post-incident analysis and future security improvements. Regular maintenance checks and automated schedules ensure that all sensors and components of the IDS are functioning correctly, contributing to the system's reliability and efficiency in maintaining building security.

A data backup system for Building Management Systems (BMS) is essential to ensure that critical operational data and configurations are preserved in the event of system failures or disruptions. The system continuously monitors and stores copies of data generated by various BMS nodes, such as sensors, controllers, HVAC systems, lighting, and security systems. Automated processes are employed to back up this data at regular intervals, ensuring that all updates and configurations are captured. In some cases, real-time data replication is implemented, where data is duplicated to remote servers or cloud storage to ensure resilience and quick recovery.

The data backup system is also designed to prevent data loss in case of hardware failure or server crashes. If a node or server fails, the backup system ensures that a failover process occurs seamlessly, switching to a secondary server or cloud instance. This failover mechanism allows uninterrupted access to data and minimal disruption to building operations. Additionally, monitoring tools keep track of the backup system's status, alerting operators or maintenance staff in real-time to any issues with backup processes or data integrity. Regular testing and scheduled maintenance are essential for ensuring the reliability of the backup system, which includes verifying backup data accuracy and ensuring that storage devices or cloud instances are properly updated. This comprehensive approach ensures the protection of critical building data and supports the continuous, efficient operation of the BMS.

It is very important for distributed BMS that both systems are closely integrated, by using pre-flight query. This query is generated by IDS to check if the node is already busy with a backup system. The backup system ensures that the IDS gets a response to the pre-flight query to plan and design the active polling session for the node in question. This integrated approach ensures that even in the event of a failure or attack, the building's security infrastructure remains intact, with critical data preserved and the system functioning optimally.

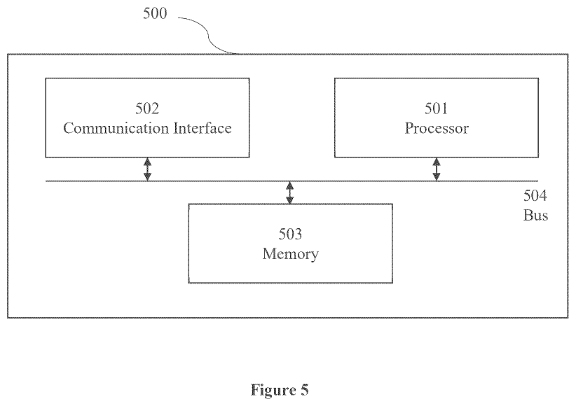

FIG. 5 illustrates a schematic diagram of a polling apparatus 500 according to an embodiment of the disclosure. The polling apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For ease of representation, the bus is represented by using only one line in FIG. 5, but it does not indicate that there is only one bus or one type of bus. The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or another programmable data processing apparatus, a function/operation specified in the flowchart and/or the block diagram is implemented. The program code may be completely executed on a computer, partially executed on a computer, independently performed as a software package, partially executed on a computer and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A secure active polling method, comprising the steps of:
creating, by an intrusion detection system, a bi-directional connection between at least one backup system and the intrusion detection system;
generating a pre-flight care query to initiate an active polling session with at least one node of a distributed control system;
querying, via the bi-directional connection, the at least one backup system using the pre-flight care query before initiating the active polling session;
receiving a response from the at least one backup system via the bi-directional connection; and
initiating the active polling session for the at least one node of the distributed control system if the response is negative; or
stalling the active polling session for a pre-set time of the at least one node of the distributed control system if the response is affirmative.

2. The method as claimed in claim 1, wherein the response is affirmative when the at least one node is either in an automated backup state or in a manual backup state.

3. The method as claimed in claim 1, wherein the response is negative when the at least one node is not in a backup state or a cloning state.

4. The method as claimed in claim 1, wherein the active polling session is a batch of active polling actions of an active polling scheme.

5. The method as claimed in claim 1, wherein the active polling session is used for cyber insights of the at least one node of the distributed control system.

6. The method as claimed in claim 1, wherein the at least one node is a device with an operating system.

7. The method as claimed in claim 1, wherein the at least one backup system is selected from a group of local servers or remote servers.

8. The method as claimed in claim 1, further comprising storing, by the intrusion detection system, the response along with a plurality of associated metadata.

9. The method as claimed in claim 8, further comprising:
generating a subsequent pre-flight care query based on the stored response being affirmative and the associated metadata before initiating an active polling session of the at least one node of the distributed control system;
querying the at least one backup system using the subsequent pre-flight care query;
receiving a subsequent response from the at least one backup system; and
initiating the active polling session for the at least one node of the distributed control system if the subsequent response is negative; or
stalling the active polling session for a subsequent pre-set time of the at least one node of the distributed control system if the subsequent response is affirmative.

10. An intrusion detection system to execute an active polling session for at least one node of a distributed control system, comprising:
a connection module configured to create a bi-directional connection between at least one backup system and the intrusion detection system;
a query formulation module configured to generate a pre-flight care query before initiating an active polling session for the at least one node of the distributed control system;
a query execution module configured to query the at least one backup system using the pre-flight care query; and
a decision module configured to receive a response from the at least one backup system via the bi-directional connection and further configured to initiate the active polling session for the at least one node of the distributed control system if the response is negative or further configured to stall the active polling session for a pre-set time for the at least one node of the distributed control system if the response is affirmative.

11. The system as claimed in claim 10, wherein the response is affirmative when the at least one node is either in an automated backup state or in a manual backup state.

12. The system as claimed in claim 10, wherein the response is negative when the at least one node is not in a backup state or a cloning state.

13. The system as claimed in claim 10, wherein the active polling session is a batch of active polling actions of an active polling scheme.

14. The system as claimed in claim 10, wherein the active polling session is used for cyber insights of the at least one node of the distributed control system.

15. The system as claimed in claim 10, wherein the at least one node is a device with an operating system.

16. The system as claimed in claim 10, wherein the at least one backup system is selected from a group of local servers or remote servers.

17. The system as claimed in claim 10, further comprising storing the response along with a plurality of associated metadata.

18. The system as claimed in claim 17, further comprising:
generating a subsequent pre-flight care query based on the stored response being affirmative and associated metadata before initiating an active polling session of the at least one node of the distributed control system;
querying the at least one backup system using the subsequent pre-flight care query;
receiving a subsequent response from the at least one backup system; and
initiating the active polling session for the at least one node of the distributed control system if the subsequent response is negative; or
stalling the active polling session for a subsequent pre-set time of the at least one node of the distributed control system if the subsequent response is affirmative.

19. The system as claimed in claim 10, wherein the pre-set time is part of a plurality of pre-set rules defined automatically by the intrusion detection system or by using a user input.

20. A non-transitory computer-readable medium having stored thereon computer-readable instructions that, when executed by a processor, cause the processor to execute a secure active polling method, comprising:
creating, by an intrusion detection system, a bi-directional connection between at least one backup system and the intrusion detection system;
generating a pre-flight care query to initiate an active polling session with at least one node of a distributed control system;
querying, via the bi-directional connection, the at least one backup system using the pre-flight care query before initiating the active polling session;
receiving a response from the at least one backup system via the bi-directional connection; and
initiating the active polling session for the at least one node of the distributed control system if the response is negative; or
stalling the active polling session for a pre-set time of the at least one node of the distributed control system if the response is affirmative.
